(19) United States
(12) Patent Application Publication
(10) Pub. No.: US 2022/0209250 A1
(43) Pub. Date: Jun. 30, 2022

(54) FUEL CELL CATALYST COATED MEMBRANE AND METHOD OF MANUFACTURE

(71) Applicant: HYZON MOTORS INC., Honeoye Falls, NY (US)

(72) Inventors: Rajesh Bashyam, Delta (CA); Joselito Venturina, NEW WESTMINSTER (CA)

(21) Appl. No.: 17/563,233

(22) Filed: Dec. 28, 2021

Related U.S. Application Data
(60) Provisional application No. 63/132,773, filed on Dec. 31, 2020.

(51) Int. Cl. H01M 4/88; H01M 4/90

(52) U.S. Cl. CPC H01M 4/8828; H01M 4/9083

(57) ABSTRACT

Methods of making catalyst-coated membranes are provided. Application of a first catalyst ink to first side of a proton-exchange membrane forms a first electrode coating thereon. Removal of a backing from the proton-exchange membrane exposes a second side of the proton-exchange membrane permitting application of a second catalyst ink to the exposed second side of the proton-exchange membrane to form a second electrode coating thereon. The cathode catalyst ink includes a cathode catalyst, a cathode ionomer, and a cathode solvent. The anode catalyst ink includes anode particles dispersed in an inert, fluorinated, and nonpolar solvent. The anode particles include an anode catalyst, a water electrolysis catalyst, and an anode ionomer.

### CROSS-REFERENCE TO RELATED APPLICATIONS

This application claims the benefit of U.S. Provisional Application No. 63/132,773, filed on Dec. 31, 2020. The entire disclosure of the above application is hereby incorporated herein by reference.

### FIELD

The present technology relates to catalyst coated membranes, including ways of making catalyst coated membranes and use thereof in membrane electrode assemblies and fuel cells.

### INTRODUCTION

This section provides background information related to the present disclosure which is not necessarily prior art.

Fuel cell systems can be used as power supplies in numerous applications, such as vehicles and stationary power plants. Such systems can deliver power economically and with environmental and other benefits. To be commercially viable, however, fuel cell systems should exhibit adequate reliability in operation, even when the fuel cells are subjected to conditions outside their preferred operating ranges.

Fuel cells convert reactants, namely, fuel and oxidant, to generate electric power and reaction products. Proton-exchange membrane fuel cells (PEM fuel cells), also referred to as polymer-electrolyte membrane fuel cells, can employ a membrane electrode assembly (MEA) comprised of a proton-exchange membrane (e.g., proton conducting ionomer) disposed between two electrodes, namely a cathode and an anode. A catalyst typically facilitates the desired electrochemical reactions at the electrodes. Separator plates or bipolar plates, including plates providing a flow field for directing the reactants across a surface of each electrode, and/or various types of gas-diffusion media, can be disposed on each side of the MEA.

In operation, the output voltage of an individual fuel cell under load can be below one volt. Therefore, in order to provide greater output voltage, multiple fuel cells can be stacked together and can be connected in series to create a higher voltage fuel cell stack. End plate assemblies can be placed at each end of the stack to hold the stack together and to compress the stack components together. Compressive force can provide sealing and adequate electrical contact between various stack components. Fuel cell stacks can then be further connected in series and/or parallel combinations with other fuel cell stacks or power sources to form larger arrays for delivering higher voltages and/or currents.

Fuel cell electrodes can include one or more catalysts and can be formed in various ways. Catalysts used in the electrodes of the MEA can include one or more various metals, including noble metals and alloys thereof, embedded and/or supported on various types of media, including proton conducting media. A carbon-supported catalyst can be used in fuel cell electrodes at both the anode and the cathode for the respective hydrogen oxidation and oxygen reduction reactions. Electrodes including the catalysts can be formed using various inks, including solutions and/or suspensions of various materials and particles. Certain fuel cell electrodes are made using wet catalyst inks that employ one or more organic solvents (e.g., alcohol) for wetting, dispersing and smoother processing of the electrode components.

Various configurations of PEM fuel cells can be used. Certain MEAs include a proton-exchange membrane, flanked by two catalyst layers (anode and cathode), which are in turn flanked by two gas diffusion layers. Configurations of MEAs in this manner are sometimes referred to as a 5-layer MEA. Alternative configurations of MEAs include 3-layer MEAs having a proton-exchange membrane with catalyst layers applied to both sides (anode and the cathode). An alternative name for this type of 3-layer MEA is a catalyst-coated membrane (CCM). One advantage attributable to the CCM configuration can be improved contact between the catalyst and the proton-exchange membrane, resulting in good ionic contact between the membrane the respective reactant. However, one issue is that application of catalyst directly to the proton-exchange membrane can cause the membrane to swell as it gets wet.

Currently, manufacture of CCMs can include either coating a catalyst layer on a fluoropolymer substrate (e.g., polytetrafluoroethylene and/or ethylene tetrafluoroethylene), where the catalyst layer coating is then transferred to the proton-exchange membrane (e.g., perfluorinated sulfonic acid membrane) through hot pressing/lamination. Alternatively, either the anode or the cathode catalyst layer can be coated directly on the proton-exchange membrane and the other catalyst layer can be coated on the fluoropolymer substrate and transferred to the membrane to form the CCM. Coating both catalyst layers directly on the proton-exchange membrane can pose certain challenges, including swelling and dimensional instability of the membrane due to the interaction of water and polar solvents with the membrane.

Accordingly, there is a continuing need for optimizing the fabrication of electrodes for use in MEAS and PEM fuel cells.

### SUMMARY

In concordance with the instant disclosure, optimized catalyst-coated membranes, including membrane electrode assemblies and fuel cells including such catalyst-coated proton-exchange membranes, and methods of making such catalyst-coated membranes have been surprisingly discovered.

The present technology includes articles of manufacture, systems, and processes that relate to making a catalyst-coated membrane. Certain methods of making a catalyst-coated membrane can include the following aspects. A first catalyst ink can be applied to a first side of a proton-exchange membrane to form a first electrode coating thereon, where a second side of the proton-exchange membrane has a backing applied thereto. The backing can be removed to expose the second side of the proton-exchange membrane. A second catalyst ink can be applied to the exposed second side of the proton-exchange membrane to form a second electrode coating thereon.

In certain embodiments, the first catalyst ink can be a cathode catalyst ink that includes a cathode catalyst, a cathode ionomer, and a cathode solvent. The cathode catalyst can include a noble metal and/or a noble metal alloy. The cathode catalyst can be supported on carbon particles. The cathode ionomer can include a sulfonated tetrafluoroethylene-based fluoropolymer-copolymer and the cathode solvent can include one or more of water, ethanol, n-propanol, isopropanol, ethylene glycol, propylene glycol, and tent-butanol.

In certain embodiments, the second catalyst ink can be an anode catalyst ink that includes a fluorinated solvent and anode particles. The anode particles can include an anode catalyst, an anode ionomer, and a water electrolysis catalyst. The anode catalyst can include a noble metal and/or a noble metal alloy. The fluorinated solvent can include one or more of a fluorinated alkane having the formula CF₃(CF₂)ₙCF₃ (where n=1 to 7), 1,1,1,3,3,5,5,7,7,7-decafluoroheptane, perfluorotripentylamine, and perfluoro-1,3-dimethylcyclohexane.

Anode particles can be made by a method that includes the following aspects. A mixture can be formed of the anode catalyst, the water electrolysis catalyst, the anode ionomer, and an anode solvent. The mixture can be dried and can be comminuted to form the anode particles. The anode catalyst can be supported on carbon particles. The anode ionomer can include a sulfonated tetrafluoroethylene-based fluoropolymer-copolymer. The water electrolysis catalyst can include one or more of ruthenium oxide, ruthenium iridium oxide, iridium ruthenium oxide, ruthenium oxide supported on zirconium oxide, ruthenium oxide supported on niobium oxide, iridium oxide supported on zirconium oxide, and iridium oxide supported on niobium oxide. The anode solvent can include one or more of water, ethanol, n-propanol, isopropanol, ethylene glycol, propylene glycol, and tent-butanol.

Such methods of making a catalyst-coated membrane and articles formed thereby can include the following aspects. The proton-exchange membrane can include a sulfonated tetrafluoroethylene-based fluoropolymer-copolymer. The backing can include polyethylene and/or polyethylene terephthalate.

In certain embodiments, the first catalyst ink can be an anode catalyst ink that includes an anode catalyst, an anode ionomer, a water electrolysis catalyst, and anode solvent. The anode catalyst can include a noble metal and/or a noble metal alloy. The anode catalyst can be supported on carbon particles. The anode ionomer can include a sulfonated tetrafluoroethylene-based fluoropolymer-copolymer. The water electrolysis catalyst can include one or more of ruthenium oxide, ruthenium iridium oxide, iridium ruthenium oxide, ruthenium oxide supported on zirconium oxide, ruthenium oxide supported on niobium oxide, iridium oxide supported on zirconium oxide, and iridium oxide supported on niobium oxide. The anode solvent can include one or more of water, ethanol, n-propanol, isopropanol, ethylene glycol, propylene glycol, and tent-butanol.

In certain embodiments, the second catalyst ink can be a cathode catalyst ink that includes a fluorinated solvent and cathode particles. The cathode catalyst can include a noble metal and/or a noble metal alloy along with a cathode ionomer. The fluorinated solvent can include one or more of a fluorinated alkane having the formula CF₃(CF₂)ₙCF₃ (where n=1 to 7), 1,1,1,3,3,5,5,7,7,7-decafluoroheptane, perfluorotripentylamine, and perfluoro-1,3-dimethylcyclohexane.

Cathode particles can be made by a method that includes the following aspects. A mixture can be formed of the cathode catalyst, the cathode ionomer, and a cathode solvent. The mixture can be dried and can be comminuted to form the cathode particles. The cathode catalyst can be supported on carbon particles. The cathode ionomer can include a sulfonated tetrafluoroethylene-based fluoropolymer-copolymer. The cathode solvent can include one or more of water, ethanol, n-propanol, isopropanol, ethylene glycol, propylene glycol, and tert-butanol.

Certain methods of making a catalyst-coated membrane can include the following aspects. A cathode catalyst ink can be applied to a first side of a proton-exchange membrane to form a cathode coating thereon. The cathode catalyst ink can include a cathode catalyst including a noble metal and/or a noble metal alloy, a cathode ionomer, and a cathode solvent. An anode catalyst ink can be applied to a second side of the proton-exchange membrane to form an anode coating thereon. The anode catalyst ink can include an anode catalyst including a noble metal and/or a noble metal alloy, a water electrolysis catalyst, an anode ionomer, and an anode solvent.

The cathode catalyst ink can be a product of a process having the following aspects. A powder mixture including the cathode catalyst, the cathode ionomer, and a polyether can be dry blended to form a blended cathode mixture. A slurry of the blended cathode mixture can be formed with the cathode solvent, thereby providing the cathode catalyst ink. The blended cathode mixture can be comminuted prior to forming the slurry of the blended cathode mixture with the cathode solvent, which can include obtaining an average particle size for the blended cathode mixture of about 0.25 microns to about 0.5 microns. The polyether can include a polyalkylene oxide formed using one or more alkylene oxides such as ethylene oxide, propylene oxide, and butylene oxide.

The anode catalyst ink can be a product of a process having the following aspects. A powder mixture including the anode catalyst, the anode ionomer, the water electrolysis catalyst, and a polyether can be dry blended to form a blended anode mixture. A slurry of the blended anode mixture can be formed with the anode solvent, thereby providing the anode catalyst ink. The blended anode mixture can be comminuted prior to forming the slurry of the blended anode mixture with the anode solvent, which can include obtaining an average particle size for the blended anode mixture of about 0.25 microns to about 0.5 microns. The polyether can include a polyalkylene oxide formed using one or more alkylene oxides such as ethylene oxide, propylene oxide, and butylene oxide.

Other aspects of such method can include the following. Applying the cathode catalyst ink to the first side of the proton-exchange membrane to form the cathode coating thereon and/or applying the anode catalyst ink to the second side of the proton-exchange membrane to form the anode coating thereon can include applying the respective ink using a slot die or a gravure coating system. The proton-exchange membrane can be in the form of a web. The noble metal can include platinum, ruthenium, and/or iridium. The cathode catalyst and/or the anode catalyst can include one or more of platinum/carbon, platinum alloy/carbon, iridium ruthenium oxide, ruthenium iridium oxide, and iridium oxide/niobium oxide. The platinum alloy can include platinum-cobalt, platinum-nickel, and/or platinum-iron. The cathode ionomer and/or anode ionomer can include a sulfonated tetrafluoroethylene based fluoropolymer-copolymer. Applying the cathode catalyst ink and/or applying the anode catalyst ink can include applying the respective ink using a slot die or a gravure coating system. The proton-exchange membrane can be in the form of a web.

The present technology further includes various catalyst-coated membranes constructed in accordance with the present teachings. Fuel cells and fuel cells stacks including one or more of such catalyst-coated membranes are also contemplated. Vehicles can also be provided that use such fuel cells and fuel cell stacks.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic flow-chart depicting an embodiment of making a catalyst-coated membrane in accordance with the present technology.

FIG. 2 is a schematic flow-chart depicting an embodiment of making a cathode catalyst for use in making the catalyst coated membrane as shown in FIG. 1.

FIG. 3 is a schematic flow-chart depicting an embodiment of making an anode catalyst for use in making the catalyst coated membrane as shown in FIG. 1.

FIG. 4 is a schematic flow-chart depicting another embodiment of making a catalyst-coated membrane in accordance with the present technology.

FIG. 5 is a schematic flow-chart depicting an embodiment of making a cathode catalyst for use in making the catalyst coated membrane as shown in FIG. 4.

FIG. 6 is a schematic flow-chart depicting an embodiment of making an anode catalyst for use in making the catalyst coated membrane as shown in FIG. 4.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology is drawn to ways of optimizing fabrication of catalyst-coated membranes, including fuel cells, fuel cell stacks, and vehicles incorporating catalyst-coated membranes. Ways of making a catalyst-coated membrane include applying a first catalyst ink to first side of a proton-exchange membrane to form a first electrode coating thereon, where a second side of the proton-exchange membrane has a backing applied thereto. This can be followed by removing the backing to expose the second side of the proton-exchange membrane, where a second catalyst ink can be applied to the exposed second side of the proton-exchange membrane to form a second electrode coating thereon.

In certain embodiments, the first catalyst ink can include the following aspects. The first catalyst ink can be a cathode catalyst ink that includes a cathode catalyst, a cathode ionomer, and a cathode solvent. The cathode catalyst can include a noble metal, a noble metal alloy, or a noble metal and a noble metal alloy. The noble metal of the cathode catalyst can include platinum supported on carbon particles or a platinum alloy supported on carbon particles. The cathode ionomer can include a sulfonated tetrafluoroethylene based fluoropolymer-copolymer. The cathode solvent can include water, and primary alcohol such ethanol, n-propanol and iso propyl alcohol. In addition to primary alcohol, alcohol such as ethylene glycol, propylene alcohol, glycol and tertiary butanol can also be employed. Further examples include where the cathode solvent includes water, ethanol, n-propanol, isopropanol, ethylene glycol, propylene glycol, and/or tent-butanol.

In certain embodiments, the second catalyst ink can include the following aspects. The second catalyst ink can be an anode catalyst ink that includes anode particles dispersed in fluorinated solvent, including an inert, fluorinated, and nonpolar solvent. The anode particles can comprise an anode catalyst, a water electrolysis catalyst, and an anode ionomer. The anode catalyst can include a noble metal, a noble metal alloy, or a noble metal and a noble metal alloy. The inert, fluorinated, and nonpolar solvent can include fluorinated alkanes having the formula CF₃(CF₂)ₙCF₃, where n=1 to 7, and also a solvent such as deca fluoro heptane, perfluorotriamylamine, hexadecafluoro cyclohexane. Further examples include where the fluorinated solvent includes a fluorinated alkane having the formula CF₃(CF₂)ₙCF₃ (where n=1 to 7), 1,1,1,3,3,5,5,7,7,7-decafluoroheptane, perfluorotripentylamine, and/or perfluoro-1,3-dimethylcyclohexane. The anode particles can be made by a method that includes forming a mixture of the anode catalyst, the water electrolysis catalyst, the anode ionomer, and an anode solvent, drying the mixture, and comminuting the dried mixture to form the anode particles. The noble metal of the anode catalyst can include platinum supported on carbon particles or a platinum alloy supported on carbon particles. The water electrolysis catalyst can include one or more of ruthenium oxide, ruthenium iridium oxide, iridium ruthenium oxide, ruthenium oxide supported on zirconium oxide, ruthenium oxide supported on niobium oxide, iridium oxide supported on zirconium oxide, and iridium oxide supported on niobium oxide. The anode ionomer can include a sulfonated tetrafluoroethylene-based fluoropolymer-copolymer.

Various ways of making a catalyst-coated membrane can include the following aspects. The proton-exchange membrane can include an ionomer. The ionomer of the proton-exchange membrane can include a sulfonated tetrafluoroethylene-based fluoropolymer-copolymer. The backing on the second side of the proton-exchange membrane can include polyethylene and/or polyethylene terephthalate, as non-limiting examples.

In certain embodiments, the first catalyst ink can include the following aspects. The first catalyst ink can be an anode catalyst ink that includes an anode catalyst, a water electrolysis catalyst, an anode ionomer, and an anode solvent. The anode catalyst can include a noble metal, a noble metal alloy, or a noble metal and a noble metal alloy. The noble metal of the anode catalyst can include platinum supported on carbon particles or a platinum alloy supported on carbon particles. The water electrolysis catalyst can include one or more of ruthenium oxide, ruthenium iridium oxide, iridium ruthenium oxide, ruthenium oxide supported on zirconium oxide, ruthenium oxide supported on niobium oxide, iridium oxide supported on zirconium oxide, and iridium oxide supported on niobium oxide. The anode ionomer can include a sulfonated tetrafluoroethylene based fluoropolymer-copolymer. The anode solvent can include water, and primary alcohol such ethanol, n-propanol and iso propyl alcohol. In addition to primary alcohol, alcohol such as ethylene glycol, propylene alcohol, glycol and tertiary butanol can also be employed. Further examples include where the anode solvent includes water, ethanol, n-propanol, isopropanol, ethylene glycol, propylene glycol, and/or tent-butanol.

In certain embodiments, the second catalyst ink can include the following aspects. The second catalyst ink can be a cathode catalyst ink that includes cathode particles dispersed in a fluorinated solvent, including an inert, fluorinated, and nonpolar solvent. The cathode particles can include a cathode catalyst and a cathode ionomer. The cathode catalyst can include a noble metal, a noble metal alloy, or a noble metal and a noble metal alloy. The inert, fluorinated, and nonpolar solvent can include fluorinated alkanes having the formula CF₃(CF₂)ₙCF₃, where n=1 to 7, and also a solvent such as deca fluoro heptane, perfluorotriamylamine, hexadecafluoro cyclohexane. Further examples include where the fluorinated solvent includes a fluorinated alkane having the formula CF₃(CF₂)ₙCF₃ (where n=1 to 7), 1,1,1,3,3,5,5,7,7,7-decafluoroheptane, perfluorotripentylamine, and/or perfluoro-1,3-dimethylcyclohexane. The cathode particles can be made by a method that includes forming a mixture of the cathode catalyst, the cathode ionomer, and a cathode solvent, drying the mixture, and comminuting the dried mixture to form the cathode particles. The noble metal of the cathode catalyst can include platinum supported on carbon particles or a platinum alloy supported on carbon particles. The cathode ionomer can include a sulfonated tetrafluoroethylene-based fluoropolymer-copolymer.

Ways of making a catalyst-coated membrane can also include the following aspects. A cathode catalyst ink can be applied to a first side of a proton-exchange membrane to form a cathode coating thereon. The cathode catalyst ink can include a cathode catalyst, a cathode ionomer, and a cathode solvent. The cathode catalyst can include a noble metal, a noble metal alloy, or a noble metal and a noble metal alloy. An anode catalyst ink can be applied to a second side of the proton-exchange membrane to form an anode coating thereon. The anode catalyst ink can include an anode catalyst, a water electrolysis catalyst, an anode ionomer, and an anode solvent. The anode catalyst can include a noble metal, a noble metal alloy, or a noble metal and a noble metal alloy. The water electrolysis catalyst can include ruthenium oxide, ruthenium iridium oxide, iridium ruthenium oxide, ruthenium oxide supported on zirconium oxide, ruthenium oxide supported on niobium oxide, iridium oxide supported on zirconium oxide, and/or iridium oxide supported on niobium oxide.

In certain embodiments, the cathode catalyst ink can include the following aspects. The cathode catalyst ink can be a product of a process comprising: dry blending a powder mixture including the cathode catalyst, the cathode ionomer, and a polyether to form a blended cathode mixture; and forming a slurry of the blended cathode mixture with the cathode solvent, thereby providing the cathode catalyst ink. It is possible to comminute the blended cathode mixture prior to forming a slurry of the blended cathode mixture with the cathode solvent, where comminuting the blended cathode mixture can include obtaining an average particle size for the blended cathode mixture of about 0.25 microns to about 0.5 microns. The polyether can include a polyalkylene oxide, where the polyalkylene oxide can include polyethylene oxide. Further examples include where the polyether includes a polyalkylene oxide formed using one or more of ethylene oxide, propylene oxide, and butylene oxide.

In certain embodiments, the anode catalyst ink can include the following aspects. The anode catalyst ink can be a product of a process that includes: dry blending a powder mixture including the anode catalyst, the water electrolysis catalyst, the anode ionomer, and a polyether to form a blended anode mixture; and forming a slurry of the blended anode mixture with the anode solvent, thereby providing the anode catalyst ink. It is possible to comminute the blended anode mixture prior to forming a slurry of the blended anode mixture with the anode solvent, where comminuting the blended anode mixture can include obtaining an average particle size for the blended anode mixture of about 0.25 microns to about 0.5 microns. The polyether can include a polyalkylene oxide, where the polyalkylene oxide can include polyethylene oxide. Further examples include where the polyether includes a polyalkylene oxide formed using one or more of ethylene oxide, propylene oxide, and butylene oxide.

The cathode catalyst ink and/or the anode catalyst ink can include the following aspects. The noble metal can include one or more of platinum, ruthenium, and iridium. The cathode catalyst and/or the anode catalyst can include one or more of platinum/carbon, platinum alloy/carbon, iridium ruthenium oxide, ruthenium iridium oxide, and iridium oxide/niobium oxide. The platinum alloy can include one or more of platinum-cobalt, platinum-nickel, and platinum-iron. The cathode ionomer and/or the anode ionomer can include a sulfonated tetrafluoroethylene based fluoropolymer-copolymer. Application of the cathode catalyst ink and/or the anode catalyst ink can include applying the respective ink using a slot die or a gravure coating system. The proton-exchange membrane can also be in the form of a web.

Ways of making catalyst coated membranes and catalyst coated membranes made thereby can be used in various applications. A fuel cell or a stack of fuel cells can include catalyst-coated membranes as described herein. Likewise, vehicles or other applications requiring an electrical power source can include a fuel cell or fuel stack incorporating catalyst coated membranes as provided by the present technology.

In certain embodiments, the present technology provides where a cathode catalyst layer, after producing such cathode catalyst ink using Pt/C or Pt-alloy catalyst with ionomer and solvents, can be coated on an ionomer (e.g., a perfluorosulfonic acid (PFSA) membrane) having a backing. The backing can provide support for chemical and mechanical stability. An anode catalyst ink can be produced using Pt/C along with a water electrolysis catalyst such as RuOx, RuIrOx, IrRuOx (with different Ru to Ir ratios) and RuOx or IrOx supported on ZrOx and or NbOx. The catalysts can be mixed with PFSA ionomer and solvent and mixed in overhead and high shear mixtures and homogenized. The catalyst ink can be dried at 80° C. for about 5 hours to about 16 hours with or without vacuum. The dried catalyst can then be comminuted or pulverized to less than 0.5 micron. The comminuted catalyst can then be mixed with non-polar and inert fluoro solvents with different vapor pressures and boiling points. The boiling point can be between 60° C. and 150° C., where the components are provided in overhead mixer at different shear and homogenized again to make sure the average particle size is less than about 0.5 micron. The anode ink based on the inert, fluorinated polar solvents can then be coated on the other side of the membrane following removal of the backing from the membrane. The fluorinated solvent is highly inert and hydrophobic the interaction of the solvent will not cause swelling or dimensional instability and can be coated directly on the membrane.

In certain embodiments, an anode catalyst layer with above components can be coated on the ionomer (e.g., a perfluorosulfonic acid (PFSA) membrane) having a backing and cathode catalyst ink with hydrophobic fluoro solvent can be directly coated on the membrane (where the backing is removed).

In certain embodiments, the anode catalyst (Pt/C and oxides mentioned above) along with dry ionomer powder and polyether, such as polyethylene oxide, without any solvents or water can be dry blended and pulverized to an average particle size of less than 0.5 micron. In a separate step, the cathode catalyst Pt/C or Pt-alloy/C, dry ionomer and polyether, such as polyethylene oxide, can be dry blended and pulverized to an average particle size of less than 0.5 micron. The dried components can then be mixed with hydrophobic fluorosolvent to separately provide anode and cathode inks. These anode and cathode inks can be coated simultaneously on a membrane including an ionomer (e.g., a perfluorosulfonic acid) using slot die or microgravure systems or other coating methods.

Certain catalysts, including cathode catalysts and anode catalysts, can include the following aspects. The catalyst can include one or more noble metals and/or noble metal alloys. The noble metal and/or the noble metal portion of the noble metal alloy can include platinum, ruthenium, and/or iridium. The catalyst can include a metal and/or noble metal deposited onto various particles, such as carbon particles. Larger particles and/or heterogeneous mixtures of particles can be comminuted to a smaller preselected size and to provide a substantially homogenous particle size distribution. The catalyst can include one or more of platinum/carbon, platinum alloy/carbon, iridium ruthenium oxide, ruthenium iridium oxide, iridium oxide/niobium oxide, as well as various combinations thereof. Where present, the platinum alloy can include platinum-cobalt, platinum-nickel, and/or platinum-iron. As noted, the catalyst can include a metal deposited onto an electrically conductive particle, such as various carbon particles. Such electrically conductive particles can be selected to have various porosities, sizes, and surface areas. It is also possible to mix various types of catalysts, including various metals deposited on various types of particles. Where the catalyst is used in forming the anode catalyst ink and anode catalyst layer or electrode, the water electrolysis catalyst can also be deposited onto electrically conductive particles (e.g., carbon particles), which can include the same particles onto which the anode catalyst is deposited or a separate population of electrically conductive particles.

Where the catalyst includes one or more metals deposited onto carbon particles, the carbon particles can have various porosities, sizes, and average surface area values. Embodiments include where the carbon particles include average surface area values that can range from about 50 m²/g to about 125 m²/g, from about 125 m²/g to about 300 m²/g, and/or from about 300 m²/g to about 1200 m²/g, as well as mixtures of such carbon particles. Examples of carbon particles include activated carbon available from Cabot Carbon Ltd., including activated carbon black available under the tradenames Vulcan™ XC-72 and BLACK PEARLS™.

The ionomer, including the cathode ionomer and/or the anode ionomer, can include the following aspects. The ionomer can include various proton conducting polymers. The ionomer can include a polyelectrolyte that comprises copolymers containing both electrically neutral repeating units and a fraction of ionized units. Various types of copolymers can be included in the ionomer, including copolymers having depending functional groups such as carboxylic acid groups and/or sulfonate groups as ionized groups. The ionomer can include a sulfonated tetrafluoroethylene-based fluoropolymer-copolymer. Certain embodiments include where the ionomer includes Nafion™ from DuPont. In certain embodiments, the ionomer can include the same ionomer present in a proton-exchange membrane to which the electrode will be associated with in forming an MEA for use in a PEM fuel cell. The ionomer can be provided as particles of various sizes and uniformities that can be comminuted to a preselected size and to provide a substantially homogenous particle size distribution. The ionomer itself, or one or more other polymers or materials associated therewith, can be at least partially thermoplastic so that particles thereof can be heated and at least softened or even partially melted. This can allow the particles, as well as other components of the blended mixture (e.g., catalyst, polyether) to interact, conforming surface portions with each other. The heating, with or without associated pressure, can operate in a sintering-like fashion to fuse the ionomer and any associated polymers or materials, including the catalyst and polyether, to form a cohesive mass, layer, or film following coating onto the substrate.

The polyether can include the following aspects. The polyether can include one or more polyalkylene oxides. The polyalkylene oxide can have an average molecular mass above about 20,000 g/mol. Certain embodiments can have molecular weights of about 100,000 g/mol, 400,000 g/mol, 1,000,000 g/mol, and 2,000,000 g/mol. Other embodiments can include various mixtures of molecular weights and ranges of molecular weights, including mixtures and ranges bounded by the preceding values. The polyalkylene oxide can include polyethylene oxide, polypropylene oxide, and/or polybutylene oxide. The polyalkylene oxide can be formed from a single alkylene oxide species or from a mixture of alkylene oxide species; e.g., a mixture of ethylene oxide and propylene oxide. Certain embodiments include where the polyalkylene oxide includes only polyethylene oxide. Where present, the polyethylene oxide can include polymers of ethylene oxide having a molecular mass above about 20,000 g/mol. Commercial examples of polyalkylene oxides include those sold under the tradenames Carbowax™ (Dow), Pluriol™ (BASF), and Dow P Series™ (Dow).

Comminuting of various components and/or bends of components can include various aspects. Comminution operations can include various pulverizing, grinding, and milling methods that reduce the average particle size of the component or blended mixture. It is also possible to comminute one, two, or all three of the catalyst, the ionomer, and the polyether prior to dry blending powders of each to form the blended mixture. Comminuting prior to dry blending can include obtaining an average particle size for the blended mixture of about 0.25 microns to about 0.5 microns. Comminuting operations can include various known processes of crushing, grinding, cutting, and/or vibrating components to obtain a preselected particle size distribution and/or to provide a substantially uniform average particle size. Examples include the use of mills, such as a ball mill, various crushers, high pressure grinding rolls, and roller presses.

The present technology provides certain benefits and advantages. These include new ways of obtaining catalyst-coated membranes that minimize swelling and dimensional instability of the membrane due to the interaction of water and polar solvents with the membrane. The present technology can be used to overcome such issues whether electrodes are formed by sequentially or simultaneously applying cathode and anode inks to the membrane. Minimizing dimensional changes in the PEM membrane can work in conjunction with the minimization of cracking or crazing in the electrodes applied thereto, ultimately forming a more stable and longer lasting catalyst coated membrane useful in MEAS of PEM fuel cells.

### EXAMPLES

Example embodiments of the present technology are provided with reference to the several figures enclosed herewith. It should be understood that the various components and operations detailed in the following examples can include the various species and details relating to each, as provided throughout the present disclosure.

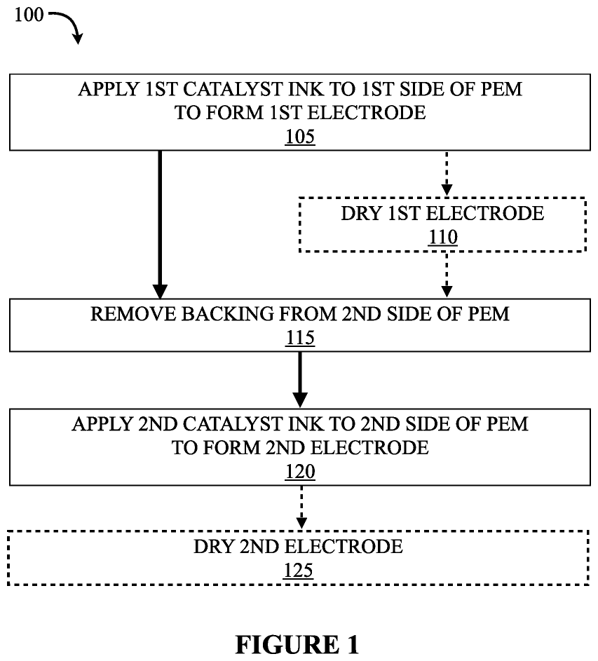

With reference to FIG. 1, an embodiment of making a catalyst-coated membrane is shown at 100. As shown at 105, a first catalyst ink is applied to a first side of a proton-exchange membrane to form a first electrode. The first electrode can optionally be dried, as shown at 110. As shown at 115, backing is removed from the second side of the proton-exchange membrane. A second catalyst ink is applied to the second side of the proton-exchange membrane to form the second electrode, as shown at 120. The second electrode can optionally be dried, as shown at 125. It should be understood that the first catalyst ink applied to the first side of the proton-exchange membrane to form the first electrode (at 105) can be one of a cathode catalyst ink and an anode catalyst ink, where the second catalyst ink applied to the second side of the proton-exchange membrane to form the second electrode (at 120) can be the other of the cathode catalyst ink and an anode catalyst ink.

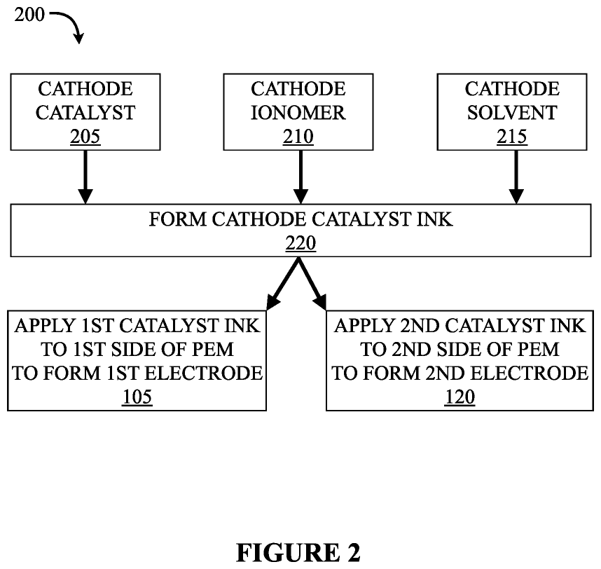

With reference to FIG. 2, an embodiment of making a cathode catalyst ink is shown at 200. A cathode catalyst 205, a cathode ionomer 210, and a cathode solvent 215 are combined to form a cathode catalyst ink, as shown at 220. The cathode catalyst ink can be used as the first catalyst ink that is applied to the first side of the proton-exchange membrane to form the first electrode, as shown at 105 in FIG. 1. Alternatively, the cathode catalyst ink can be used as the second catalyst ink that is applied to the second side of the proton-exchange membrane to form the second electrode, as shown at 120 in FIG. 1.

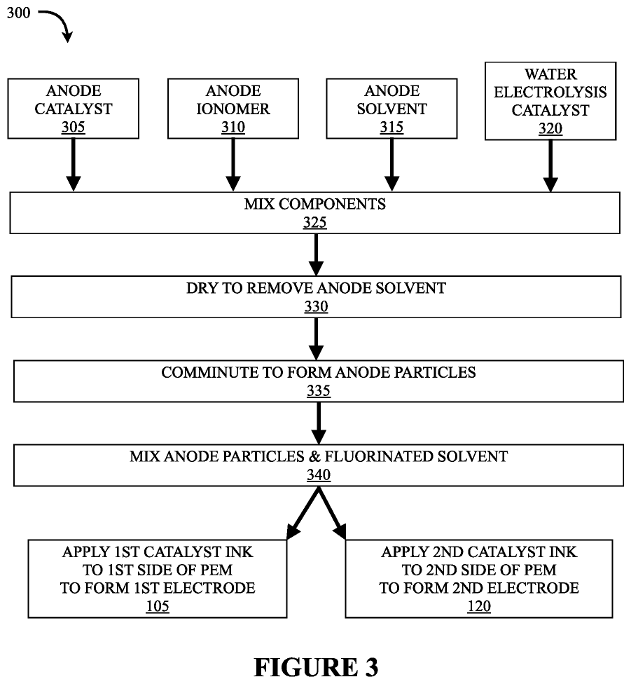

With reference to FIG. 3, an embodiment of making an anode catalyst ink is shown at 300. An anode catalyst 305, an anode ionomer 310, an anode solvent 315, and a water electrolysis catalyst 320 are mixed together, as shown at 325. The mixed components are dried to remove the anode solvent, as shown at 330. Next, as shown at 335, the dried mixture is comminuted to form anode particles. As shown at 340, the anode particles and a fluorinated solvent are mixed. The anode catalyst ink can be used as the first catalyst ink that is applied to the second side of the proton-exchange membrane to form the second electrode, as shown at 120 in FIG. 1. Alternatively, the anode catalyst ink can be used as the second catalyst ink that is applied to the first side of the proton-exchange membrane to form the first electrode, as shown at 105 in FIG. 1.

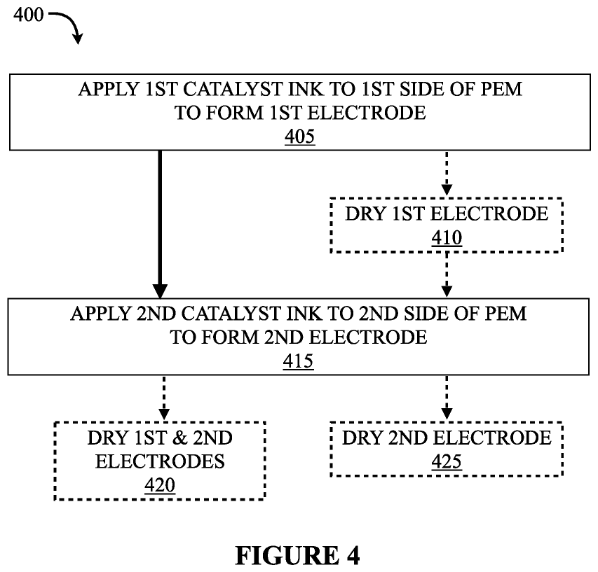

With reference to FIG. 4, another embodiment of making a catalyst-coated membrane is shown at 400. A first catalyst ink is applied to a first side of a proton-exchange membrane to form a first electrode, as shown at 405. Optionally, as shown at 410, the first electrode can be dried. A second catalyst ink is applied to a second side of the proton-exchange membrane to form a second electrode, as shown at 415. Where the first electrode was not subjected to the preceding drying step at 410, the first and second electrodes can be dried together, as shown at 420. Alternatively, where the first electrode was already dried at 410, the second electrode can be subsequently dried, as shown at 425.

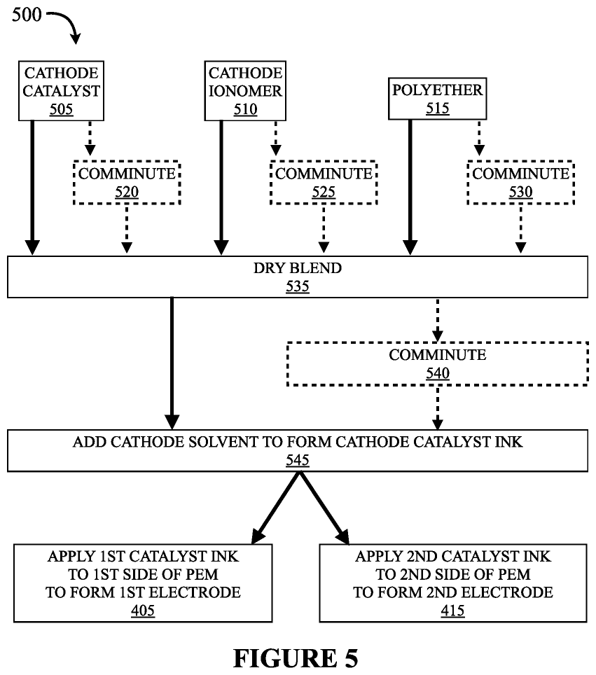

With reference to FIG. 5, another embodiment of making a cathode catalyst is shown at 500. A cathode catalyst 505, a cathode ionomer 510, and a polyether 515 are provided, where one or more of each can be optionally comminuted to produce a desired particle size or uniformity, as indicated at 520, 525, 530. The cathode catalyst 505, the cathode ionomer 510, and the polyether 515 are then combined to form a dry blend, as shown at 535. The dry blend can be optionally comminuted, as shown at 540, which can be in addition to or in lieu of one or more of the preceding optional comminuting steps 520, 525, 530. Cathode solvent is then added, as shown at 545, to form a cathode catalyst ink. The cathode catalyst ink can be used as the first catalyst ink that is applied to the first side of the proton-exchange membrane to form the first electrode, as shown at 405 in FIG. 4. Alternatively, the cathode catalyst ink can be used as the second catalyst ink that is applied to the second side of the proton-exchange membrane to form the second electrode, as shown at 415 in FIG. 4.

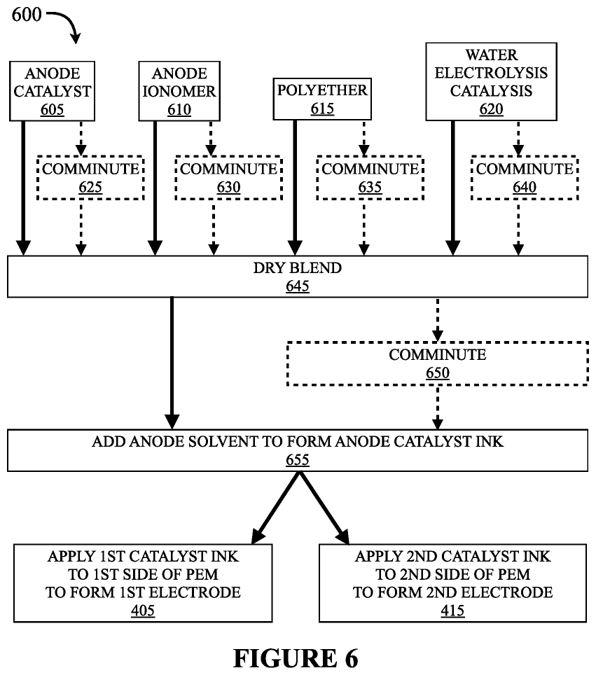

With reference to FIG. 6, another embodiment of making an anode catalyst is shown at 600. An anode catalyst 605, an anode ionomer 610, a polyether 615, and a water electrolysis catalyst 620 are provided, where one or more of each can be optionally comminuted to produce a desired particle size or uniformity, as indicated at 625, 630, 635, 640. The anode catalyst 605, the anode ionomer 610, the polyether 615, and the water electrolysis catalyst 620 are then combined to form a dry blend, as shown at 645. The dry blend can be optionally comminuted, as shown at 650, which can be in addition to or in lieu of one or more of the preceding optional comminuting steps 625, 630, 635, 640. Anode solvent is then added, as shown at 655, to form an anode catalyst ink. The anode catalyst ink can be used as the second catalyst ink that is applied to the second side of the proton-exchange membrane to form the second electrode, as shown at 415 in FIG. 4. Alternatively, the anode catalyst ink can be used as the first catalyst ink that is applied to the first side of the proton-exchange membrane to form the first electrode, as shown at 405 in FIG. 4.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method of making a catalyst-coated membrane, comprising:
applying a first catalyst ink to a first side of a proton-exchange membrane to form a first electrode coating thereon, where a second side of the proton-exchange membrane has a backing applied thereto;
removing the backing to expose the second side of the proton-exchange membrane; and
applying a second catalyst ink to the exposed second side of the proton-exchange membrane to form a second electrode coating thereon.

2. The method of claim 1, wherein the first catalyst ink is a cathode catalyst ink comprising:
a cathode catalyst including a member selected from a group consisting of a noble metal, a noble metal alloy, and combinations thereof;
a cathode ionomer; and
a cathode solvent.

3. The method of claim 2, wherein:
the cathode catalyst is supported on carbon particles;
the cathode ionomer includes a sulfonated tetrafluoroethylene-based fluoropolymer-copolymer; and
the cathode solvent includes a member selected from a group consisting of: water, ethanol, n-propanol, isopropanol, ethylene glycol, propylene glycol, tent-butanol, and combinations thereof.

4. The method of claim 2, wherein the second catalyst ink is an anode catalyst ink comprising:
a fluorinated solvent; and
anode particles including:
an anode catalyst including a member selected from a group consisting of: a noble metal, a noble metal alloy, and combinations thereof;
an anode ionomer; and
a water electrolysis catalyst.

5. The method of claim 4, wherein the anode particles are made by a method comprising:
forming a mixture of the anode catalyst, the water electrolysis catalyst, the anode ionomer, and an anode solvent;
drying the mixture; and
comminuting the dried mixture to form the anode particles.

6. The method of claim 4, wherein:
the anode catalyst is supported on carbon particles;
the anode ionomer includes a sulfonated tetrafluoroethylene-based fluoropolymer-copolymer; and
the water electrolysis catalyst includes a member selected from a group consisting of: ruthenium oxide, ruthenium iridium oxide, iridium ruthenium oxide, ruthenium oxide supported on zirconium oxide, ruthenium oxide supported on niobium oxide, iridium oxide supported on zirconium oxide, iridium oxide supported on niobium oxide, and combinations thereof.

7. The method of claim 5, wherein the anode solvent includes a member selected from a group consisting of: water, ethanol, n-propanol, isopropanol, ethylene glycol, propylene glycol, tent-butanol, and combinations thereof.

8. The method of claim 1, wherein:
the proton-exchange membrane includes a sulfonated tetrafluoroethylene-based fluoropolymer-copolymer; and
the backing includes a member selected from a group consisting of polyethylene, polyethylene terephthalate, and combinations thereof.

9. The method of claim 1, wherein the first catalyst ink is an anode catalyst ink comprising:
an anode catalyst including a member selected from a group consisting of a noble metal, a noble metal alloy, and combinations thereof;
an anode ionomer;
a water electrolysis catalyst; and
an anode solvent.

10. The method of claim 9, wherein:
the anode catalyst is supported on carbon particles;
the anode ionomer includes a sulfonated tetrafluoroethylene-based fluoropolymer-copolymer;
the water electrolysis catalyst includes a member selected from a group consisting of: ruthenium oxide, ruthenium iridium oxide, iridium ruthenium oxide, ruthenium oxide supported on zirconium oxide, ruthenium oxide supported on niobium oxide, iridium oxide supported on zirconium oxide, iridium oxide supported on niobium oxide, and combinations thereof; and
the anode solvent includes a member selected from a group consisting of: water, ethanol, n-propanol, isopropanol, ethylene glycol, propylene glycol, tent-butanol, and combinations thereof.

11. The method of claim 9, wherein the second catalyst ink is a cathode catalyst ink comprising:
a fluorinated solvent; and
cathode particles including:
a cathode catalyst including a member selected from a group consisting of: a noble metal, a noble metal alloy, and combinations thereof; and
a cathode ionomer.

12. The method of claim 11, wherein the cathode particles are made by a method comprising:
forming a mixture of the cathode catalyst, the cathode ionomer, and a cathode solvent;
drying the mixture; and
comminuting the dried mixture to form the cathode particles.

13. The method of claim 12, wherein
the cathode catalyst is supported on carbon particles;
the cathode ionomer includes a sulfonated tetrafluoroethylene-based fluoropolymer-copolymer; and
the cathode solvent includes a member selected from a group consisting of: water, ethanol, n-propanol, isopropanol, ethylene glycol, propylene glycol, tent-butanol, and combinations thereof.

14. A method of making a catalyst-coated membrane, comprising:
applying a cathode catalyst ink to a first side of a proton-exchange membrane to form a cathode coating thereon, the cathode catalyst ink including: a cathode catalyst including a noble metal, a noble metal alloy, or a noble metal and a noble metal alloy; a cathode ionomer; and a cathode solvent; and
applying an anode catalyst ink to a second side of the proton-exchange membrane to form an anode coating thereon, the anode catalyst ink including: an anode catalyst including a noble metal, a noble metal alloy, or a noble metal and a noble metal alloy; a water electrolysis catalyst; an anode ionomer; and an anode solvent.

15. The method of claim 14, wherein the cathode catalyst ink is a product of a process comprising:
dry blending a powder mixture including the cathode catalyst, the cathode ionomer, and a polyether to form a blended cathode mixture; and
forming a slurry of the blended cathode mixture with the cathode solvent, thereby providing the cathode catalyst ink.

16. The method of claim 15, further comprising comminuting the blended cathode mixture prior to forming the slurry of the blended cathode mixture with the cathode solvent.

17. The method of claim 15, wherein the polyether includes a polyalkylene oxide formed using an alkylene oxide selected from a group consisting of: ethylene oxide, propylene oxide, butylene oxide, and combinations thereof.

18. The method of claim 14, wherein the anode catalyst ink is a product of a process comprising:
dry blending a powder mixture including the anode catalyst, the anode ionomer, the water electrolysis catalyst, and a polyether to form a blended anode mixture; and
forming a slurry of the blended anode mixture with the anode solvent, thereby providing the anode catalyst ink.

19. The method of claim 18, further comprising comminuting the blended anode mixture prior to forming the slurry of the blended anode mixture with the anode solvent.

20. The method of claim 15, wherein the polyether includes a polyalkylene oxide formed using an alkylene oxide selected from a group consisting of: ethylene oxide, propylene oxide, butylene oxide, and combinations thereof.
